(19) United States
(12) Patent Application Publication
(10) Pub. No.: US 2016/0128467 A1
(43) Pub. Date: May 12, 2016

(54) HEIGHT ADJUST SENSING AND CONTROL SYSTEM AND METHOD FOR AN ADJUSTABLE WORK DESK

(71) Applicant: TOME, INC., Ferndale, MI (US)

(72) Inventors: Jacob R. SIGAL, Ferndale, MI (US); Massimo BALDINI, Beverly Hills, MI (US); Philip J. DANNE, Royal Oak, MI (US); Eric C. BARCH, Oxford, MI (US); Anthony LAWRENCE, Royal Oak, MI (US)

(21) Appl. No.: 14/930,070

(22) Filed: Nov. 2, 2015

Related U.S. Application Data
(60) Provisional application No. 62/077,951, filed on Nov. 11, 2014.

(51) Int. Cl. A47B 21/02; H04W 4/00; G05B 15/02

(52) U.S. Cl. CPC A47B 21/02; G05B 15/02; H04W 4/008

(57) ABSTRACT

The present disclosure relates to a furniture height adjustment system. The system has a height adjust system positionable on or adjacent a work surface of a furniture component, wherein the work surface is movable elevationally between lowered and raised positions. The height adjust system has a processor and a height adjust setting control in communication with the processor. The height adjust setting control has user actuatable controls for enabling a user to set and store at least one elevational position for the work surface. The processor monitors movement of the work surface when the user is moving the work surface to a previously stored elevational position and generates a signal when the work surface reaches the stored elevational position.

### CROSS-REFERENCE TO RELATED APPLICATIONS

This application claims the benefit of U.S. Provisional Application No. 62/077,951, filed on Nov. 11, 2014, the entire disclosure of the above application is incorporated herein by reference.

### FIELD

The present disclosure relates to furniture such as office desks and work tables, and more particularly to a system for assisting a user in accurately adjusting a height of a user adjustable, sit/stand work desk to better and more easily enable a user to position the work desk in both seated and standing positions.

### BACKGROUND

The statements in this section merely provide background information related to the present disclosure and may not constitute prior art.

There is a growing interest in promoting health and well being in the office environment. This extends to encouraging workers to stand at their desks to perform various tasks such as participating in teleconferences, webinars, video conferences, etc. Business entities and their employers are increasingly realizing the benefit of standing while working. Many tasks, such as those mentioned above, as well as managing email, creating or managing spreadsheets, drafting documents, etc., can also be performed with relative ease while standing. Working while standing can burn significantly more calories than working while sitting. Some estimates provide that standing at a work desk and performing routine work tasks (e.g., talking on the telephone, managing email, drafting documents, etc.) can burn up to 50 calories or more per hour over what a person would burn while performing the same activities in a seated position. Sitting for prolonged periods can potentially also aggravate existing back problems, and possibly even cause some back issues depending on the sitting posture of the individual.

To facilitate working while standing some manufacturers have introduced work desks that can be raised and lowered by the individual. Some of these adjustable height desks are motorized and use an electric motor to raise and lower the desk, while others employ some type of counterweight mechanism and are manually lifted and lowered by the user to the desired positions with the help of the counterweight system. In either case, there is no means to inform the user when the desk is at exactly the same height. Some desk systems rely on markings somewhere on a frame portion of the desk to indicate different heights, but still the user is required to carefully watch and adjust the position of the desk to an approximate, desired position each and every time the user changes the desk height. This applies for both raising the lowering the desk.

Accordingly, it would be highly desirable to provide some type of system that allows the user to precisely set and store one or more preferred desk heights. Such a system would enable the user to set a precise height for the desk when the desk is in a lowered position as well as when the desk is in a raised position. It would also be desirable if the system enables multiple users to store preferred heights for the same desk, and the system is able to recognize which user is using the desk system and automatically apply the preferred height settings for a specific user through one or easily accessible user controls. It would also be desirable if the system is able to receive ergonomic information or data based on actual physical measurements of physical biometric traits of the individual, by which the height of the desk system can be set.

### SUMMARY

In one aspect the present disclosure relates to a furniture height adjustment system. The system may comprise a height adjust system configured to be positioned on or adjacent a work surface of a furniture component, wherein the work surface is movable elevationally between a lowered position and a raised position. The height adjust system may include a processor and a height adjust setting control in communication with the processor. The height adjust setting control includes user actuatable controls for enabling a user to set and store at least one elevational position at which the work surface can be set at. The processor is further configured to monitor movement of the work surface when the user is moving the work surface to a previously stored elevational position. The processor generates a signal when the work surface reaches the stored elevational position.

In another aspect the present disclosure relates to a furniture height adjustment system which includes a height adjust system. The height adjustment system is configured to be positioned on or adjacent a work surface of a furniture component, wherein the work surface is movable elevationally by a user between a lowered position and a raised position. The height adjust system may include a processor and a height adjust setting control in communication with the processor. The height adjust setting control includes user actuatable controls for enabling a user to set and store at least one elevational position at which the work surface can be set at. The processor is configured to monitor movement of the work surface when the user is moving the work surface to a previously stored elevational position. The processor generates a signal when the work surface reaches the stored elevational position. A user present detection system is included for detecting the presence of a user when the user is in proximity to the furniture component.

In still another aspect the present disclosure relates to a method for monitoring an elevational position of a work surface of a furniture component. The method may comprise using a height adjust system configured to be positioned on or adjacent a work surface of a furniture component, wherein the work surface is movable by a user elevationally between a lowered position and a raised position, to monitor a real time elevational position of the work surface relative to a ground surface. A processor and a height adjust setting control are used and in communication with one another. The processor enables a user to select and store at least one elevational position at which the work surface can be set at. The method further involves using the processor to monitor movement of the work surface when the user is moving the work surface to a previously stored elevational position. The processor is also used to generate a signal to the user when the work surface reaches the stored elevational position.

### BRIEF DESCRIPTION OF THE DRAWINGS

The drawings described herein are for illustration purposes only and are not intended to limit the scope of the present disclosure in any way.

FIG. 1 is a high level illustration of one embodiment of a system in accordance with the present disclosure for enabling quick, accurate adjustments of the height of a work desk;

FIG. 2 is a high level block diagram of one embodiment of the height control system shown in FIG. 1; and

FIGS. 3A and 3B represent a flowchart of various operations that may be performed by the system during use.

### DETAILED DESCRIPTION

The following description is merely exemplary in nature and is not intended to limit the present disclosure, application, or uses. It should be understood that throughout the drawings, corresponding reference numerals indicate like or corresponding parts and features.

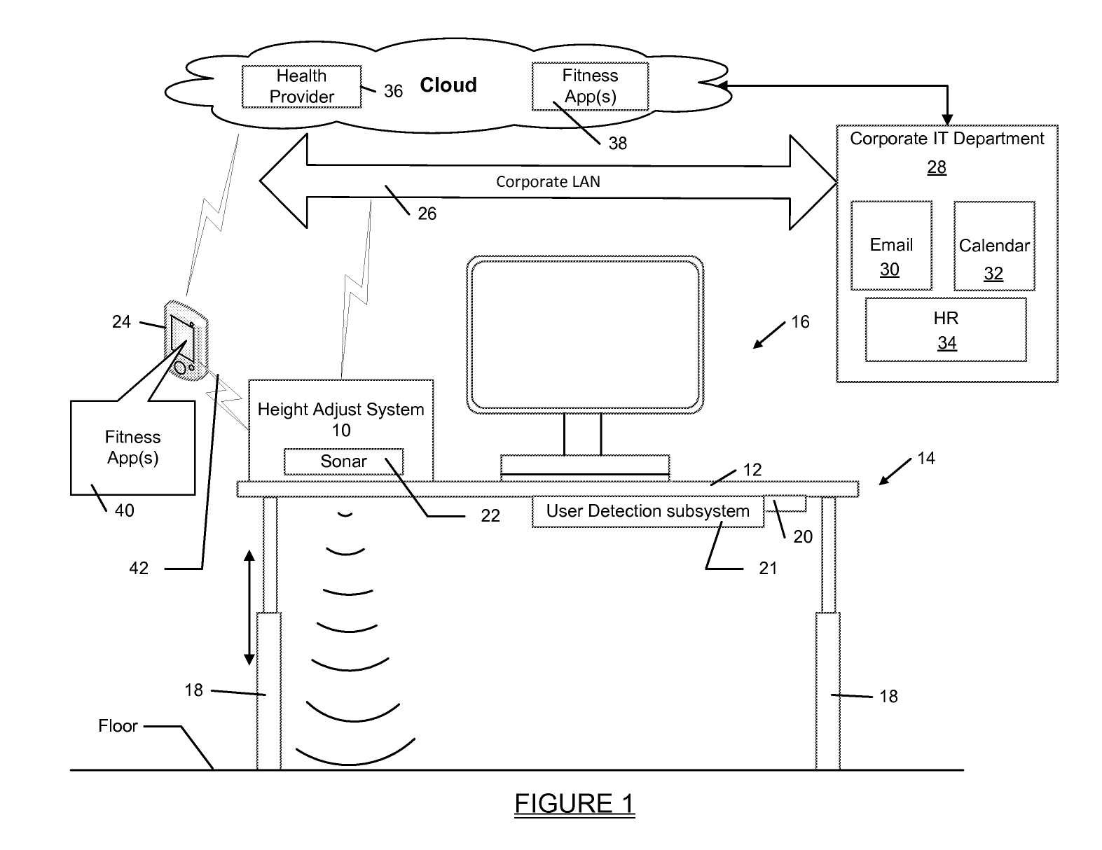

Referring to FIG. 1, there is shown a height adjust system 10 in accordance with one embodiment of the present disclosure. The height adjust system 10 (hereinafter simply “system 10”) may be positioned on a desk surface 12 of a desk 14, or underneath the desk surface 12 or alongside the desk surface 12. For convenience of explanation and illustration, the system 10 will be discussed as being presented on top of the desk surface 12, although it is expected that in most instances it may be even more desirable to mount the system 10 underneath the desk surface to maximize the available desk space for use by the user. In actual implementation, it is only important that the system 10 be mounted so that it moves with the desk surface 12. Alternatively, it is possible that a sensor component of the system 10, to be described momentarily, may be physically attached somewhere to the desk surface 12, while the remainder of the system 10 is positioned on a stationary panel or leg portion of the desk 14, or possibly on the ground adjacent the desk 14.

The desk surface 12, in one embodiment, is used to support a computer system 16 or other form of personal electronic device that the user needs to use. Accordingly, the desk 14 may be used to support a laptop, a table or any other type of computing device and is not limited to use with a desktop computer. However, as will be appreciated from the following discussion, the system 10 is not limited to use in office or home environments with computing devices. The system 10 can be used in connection with assembly tables or any other desk/table like structure used in a factory setting where setting two or more user adjustable heights would enhance the convenience, productivity and/or comfort to the user while performing the same tasks or performing different tasks at the desk/table like structure. It is also possible that the system 10 could be employed in connection with shelving systems used in warehouses to store goods that employees need to access frequently.

The desk 14 may be constructed to have one leg or a plurality of legs 18. Merely as one example, the desk 14 has been shown in FIG. 1 as having a plurality of the legs 18. The legs 18 each have a telescoping construction that enables the height of the desk surface 12 to be manually adjusted. A user control 20 is included that releases a locking mechanism (not shown) and allows the user to manually raise and lower the desk surface 12. Alternatively, the desk surface 12 may be raised and lowered by an electric motor, with control 20 allowing up or down travel of the desk surface 12. The system 10 is not limited to use with any particular type of desk (i.e., manually adjustable height or motor driven height control). It is a principal feature of the system 10 that it can be used with desks having either a manually adjustable height or a motor driven height adjusting system. It is also a significant feature of the system 10 that it can be easily retrofitted to either style of desk with no modifications being required to the desk itself. And it will be appreciated that the system 10 could be used with an independent adjustable-height platform, that rests on an otherwise fixed height desk. In such an embodiment the system 10 would be sensing the height from either the fixed upper surface of the desk, to a riser or platform that is raisable and lowerable by the user, or alternatively from the floor surface to the riser or platform.

The system 10 may include a user detection system 21, which in one example may be an infrared (IR) sensing system. The user detection subsystem 21 may be positioned relative to the desk 14 to be able to detect the presence of a user at the desk and to provide a signal (wireless or through a wired connection) to the system 10. The system 10 also makes use of a wireless sensor 22, in one embodiment a sonar sensor 22, for real time sensing of the height of the desk surface 12 relative to a floor on which the desk 14 is supported, or alternatively relative to a fixed height desk surface on which is supported an adjustable height platform or riser. For the purpose of discussion, the example where an adjustable height desk will be used. The system 10 may communicate via a short range wireless link, such as a Bluetooth® protocol signal link, a ZigBee® protocol wireless link, or any other suitable form of wireless near field communication link, with the user's smartphone 24. The system 10 may also communicate via a short range wireless link (e.g., Bluetooth® protocol link, ZigBee® protocol link, etc.) with a corporate LAN 26. The system 10 may also communicate via the LAN 26 with a corporate IT department 28 where servers are present for managing the email accounts 30 and calendars 32 of various users. A human resources (HR) department 34 may be in communication with the email accounts 30 and the calendars 32. The corporate IT department 28 may also be in communication with one or more cloud-based services, for example a health provider 36 and/or one or more personal or corporate wellness fitness applications 38.

The user's smartphone 24 may also optionally contain one or more fitness applications 40 stored thereon, or otherwise may access the one or more cloud-based fitness applications 38. The smartphone 24 also may be used to identify the user to the system 10 via the short range wireless signal link 42 (e.g., Bluetooth® protocol, ZigBee® protocol link or other type of link) established between the smartphone 24 and the system 10.

The system 10 allows the user to quickly raise and lower the desk surface 12, either manually or with the assistance of a motor driven lift mechanism, to a precise, previously set height, and to provide the user with a signal when the desk surface is at the previously set height. The system 10 also enables multiple users who have their own preset heights saved in the system 10 to use the 10 without the need for entering an identification parameter. The system 10 may automatically identify the user based on the wireless connection with the user's smartphone, and then may automatically notify the user when his/her preset desk height is reached as the user raises or lowers the desk surface 12. This facilitates highly convenient use of a desk that needs to be shared by two or more individuals, and where the different individual will want to use the desk 14 in both standing and seated positions.

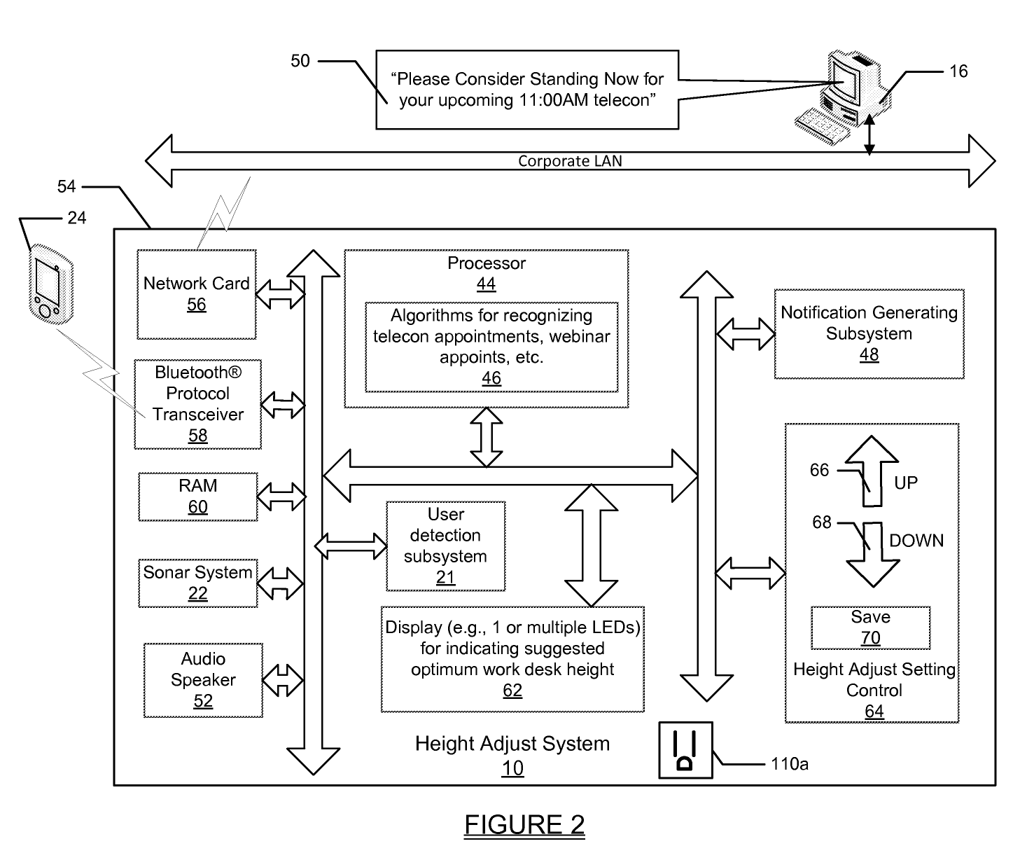

Referring to FIG. 2 the system 10 one example of the construction of the system 10 is shown. AC power may be provided to the system via a conventional AC outlet jack 10a. DC power from a suitable battery could alternatively be used to power the components of the system 10. In addition to the sensor 22, which is illustrated in this example as a sonar sensor, the system 10 may include a processor 44 with suitable on-board or off-board memory for storing algorithms 46 for recognizing key words on the user's calendar. The key words may be, for example, “webinar”, “teleconference”, “videoconference”, “WebEx”, etc., or any other word that indicates an activity that may potentially be performed easily while standing. The processor 44 may use the results of the algorithms to detect and suggest to the user when standing would be possible for an upcoming appointment, and to provide a notification 50 of such via a notification generating subsystem 48. The notification may be pushed on to the user's display system associated with his/her computer system 16. Alternatively, a pre-recorded message may be played through an audio speaker 52 housed within a cabinet or housing 54 of the system 10.

The system 10 may also have a network card 56 for communicating with the corporate LAN 26, a short range, wireless protocol transceiver 58 (e.g., Bluetooth protocol transceiver, ZigBee protocol transceiver, etc.), a random access memory (RAM) 60 for storing different preset heights by different users, and a display system 62 (LED or LCD) for indicating to the user when the desk surface 12 is at a predetermined height during a raising or lowering action of the desk surface. In one embodiment a plurality of LEDs may be used, or alternatively a multi-colored LED, which provides different optical signals to the user (e.g., green light, yellow light, red light) as the desk surface 12 is being raised or lowered to indicate to the user how close the user is to his/her preset height. Providing a green optical signal may indicate to the user that the desk surface is at exactly the preset height, while a yellow light may signal to the user that the desk surface 12 height is within an inch or two of the present height, and the red light may signal that the desk height is well outside of its preset height. These height indicating signals may be provided when the desk surface is being raised or lowered, to thus indicate to the user when the desk surface 12 reaches a preset elevated height or when it reaches a preset lowered height.

A height adjust setting control 64 may be included in the system 10 for enabling the user to save a lowered and elevated heights for the desk surface 12. An “UP” control may be pressed by the user after the desk surface 12 is positioned at a desired height by the user, and then a “SAVE” control 70 may be pressed which saves the elevated height in memory. Alternatively, these different height settings could be saved using a suitable software application running on the computing device which is present on the desk surface 12. Such a modification would require the system 10 to output signals indicative of saved height positions to the computing device. It is also possible that the height settings could be communicated to and saved on a personal electronic device of the user such as a smartphone or computing tablet, using a wireless near field communications link (e.g., Bluetooth® protocol or ZigBee® protocol wireless link). Such a modification would require suitable height position signals to be sent from the system 10 to the user's smartphone or tablet, and then recalled by the system 10 to aid the system 10 in determining the saved height positions for a specific user, provided the user's smartphone or tablet is proximity to the system 10, with the required software application running on the smartphone or tablet.

During the process of raising the desk surface 12 to the desired height, the sonar system 22 will be providing signals to the processor 44 which enable the processor 44 to highly accurately determine the height of the desk surface 12. When the user presses the SAVE 70 control after pressing the UP control 66, the processor stores this height as a preset elevated height for the desk surface 12 in the RAM 60. Optionally, an identification of the user may be stored as well by using the wireless link with the user's smartphone which identifies the user to the system 10. When the user is lowering the desk surface 12 the sonar system 22 is likewise monitoring the real time height of the desk surface and sending signals to the processor 44 which enable the processor to determine the real time height of the desk surface 12. When the user has the desk surface lowered to an optimum height, the user may press the “DOWN” control 68 and then the SAVE control 70, which saves the lowered position of the desk surface 12 in the RAM 60. Thereafter, if the user wants to raise the desk surface 12 from its preset lowered position to the preset elevated position, the user would simply begin lifting the desk surface (if the desk surface is manually adjustable) or engage the appropriate control to cause a motor to begin lifting the desk surface. The display 62 will provide an optical signal to the user as the user gets close to the preset elevated height (e.g., yellow LED being illuminated), and a different optical signal (e.g., green LED being lit) will be provided once the height is at exactly the preset elevated height. Optionally or in addition to the optical signals, a tone may be provided from the audio speaker 52 when the elevated preset height is reached. The same operations may be performed by the system 10 when the desk surface 12 is lowered.

It will be noticed that the user is not required to enter any commands to the system 10 once the lowered and elevated height presets are saved in the system 10. Whenever the user needs to raise or lower the desk surface 12 the user simply starts raising or lowering the desk surface and the system 10 will detect whether the action is a raising or lowering action and notify the user when the proper preset has been reached. Thus, the desk surface 12 can be repeatedly moved between lowered and elevated heights by the user and it will always be repositioned at exactly the appropriate preset height (either for elevated use or lowered position use).

The height adjust setting control 64 may also be modified with the addition of a keyboard which would enable a user to enter a code identifying him/her to the system 10. The processor 44 would store such codes along with the specific presets saved by the user. This option would enable multiple users to use the system without the need for some external means of identifying users to the system 10 (e.g., without a smartphone and its Bluetooth® protocol or ZigBee® protocol wireless link). Once the user has entered his/her code, the system 10 would thereafter use the appropriate presets for that particular user.

Another feature that the system 10 is the user detection subsystem 21 that detects the physical presence of a user at the work desk 14. The user detection subsystem 21 may be either an optical or sonar based subsystem that continuously monitors when the user is physically present at the work desk, regardless if the user is standing or seated. The user detection subsystem 21 generates appropriate signals that the processor 44 uses to determine if the user is present at the desk surface. During those periods where the user is standing, the processor 44 may transmit information either to the Corporate IT department 28 or to one or more cloud-based subsystems, for example health provider 36 in FIG. 1, which allows the standing time of the user to be logged. This information may be used by the corporate IT department 28 and/or the health provider, or any other connected entity, for purposes of promoting and encouraging the use of the desk 14 in the standing orientation. Such promoting and encouraging may be done through gamification programs implemented by the HR department 34 and/or the health provider 36, or any other entity. But in either event, the user present detection subsystem 21 enables the system 10 to detect those times that the user is actually at the work desk 14 and working while in a standing position.

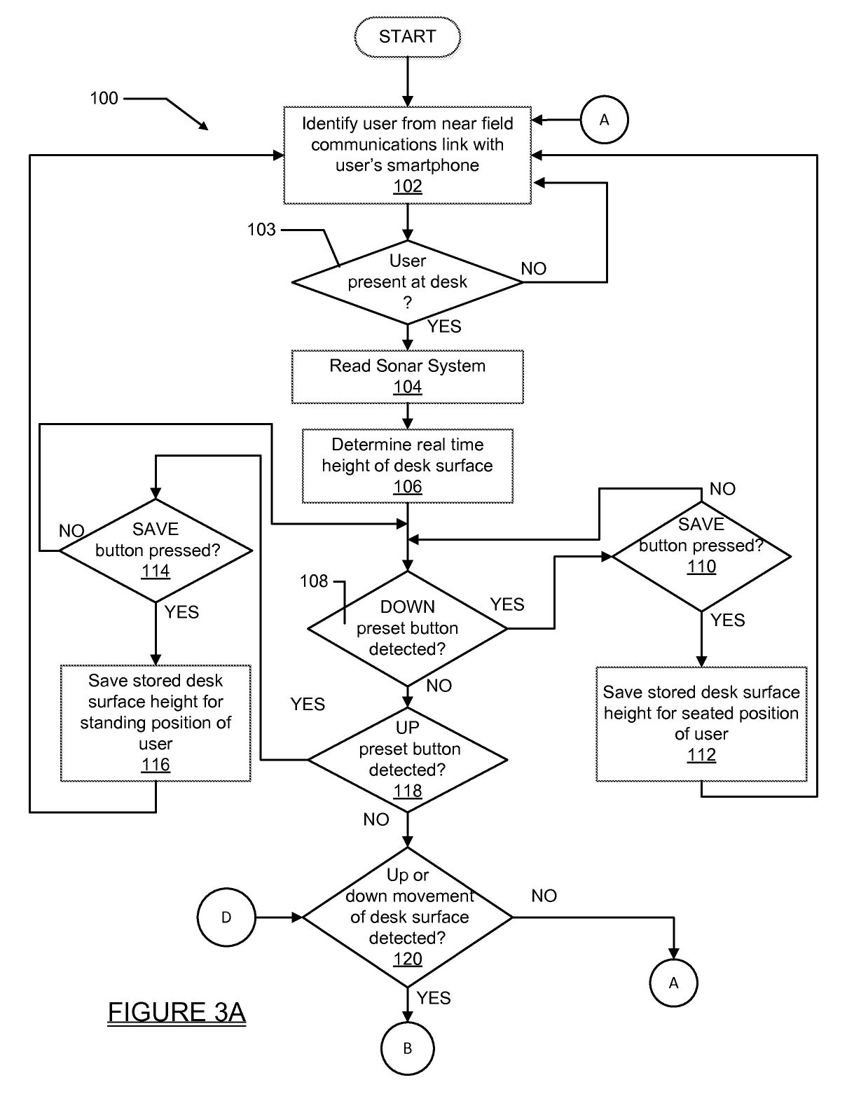

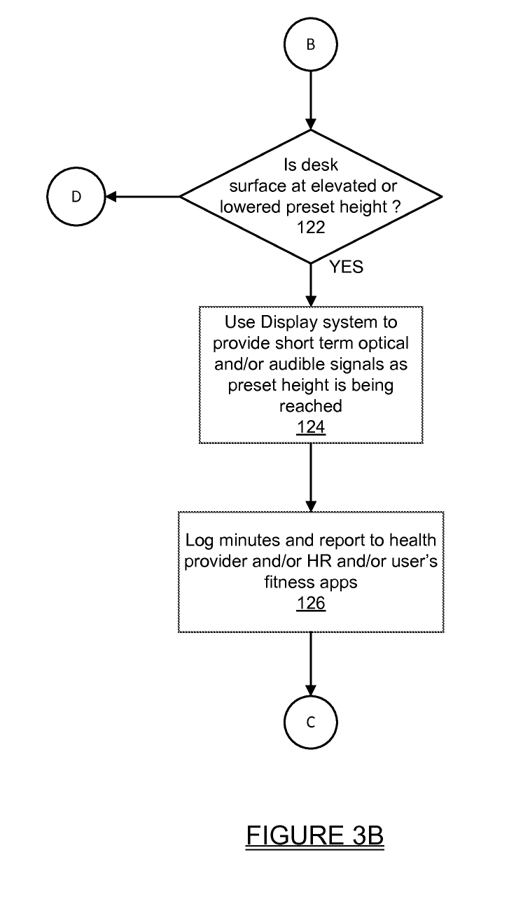

Referring to FIGS. 3A and 3B, a flowchart 100 illustrates various operations that may be performed by the system 100 during use. At operation 102 the system 10 may initially identify the user to the system 10. This may be done by use of the near field communications link (e.g., Bluetooth® protocol or ZigBee® protocol link) with the user's smartphone 24, or possibly by identifying a tablet that the user is carries with him/her.

At operation 103 the system 10 makes a determination by use of the user detection system 21 if the user is actually physically present at the desk 14. If no user is detected, then operation 102 may be re-performed.

At operation 104 the processor 44 reads or obtains signals from the sonar system 22. At operation 106 the processor 44 determines the real time height of the desk surface 12. At operation 108 a check is made if the DOWN preset control 68 has been pressed, indicating that the user is attempting to program a lowered desk surface height. If the check at operation 108 is produces a “Yes” answer, then the processor 44 checks to determine if the SAVE button 70 has been pressed, as indicated at operation 110, which indicates that a lowered preset desk position is being entered by the user. If the SAVE button 70 has been pressed at operation 110, then the processor 44 saves the lowered desk height for the user in the RAM 60. Similarly, if the test at operation 118 indicates that the UP preset control 66 has been pressed, then the system 10 checks to determine if the user has pressed the SAVE control 70, as indicated at operation 114. If so, then the current elevated height of the desk surface 12 is saved by the processor 44 in the RAM 60, as indicated at operation 116. The saved lowered and elevated desk surface presets may be associated with the particular user, provided the system 10 is constructed to accommodate saving presets for multiple different users.

At operation 120, the system 10 is continually checking, in real time, to determine if the desk surface is being moved from one of its elevated or lowered preset positions. If the check at operation 120 indicates that the desk surface 12 is being moved, then at operation 122 (FIG. 3B) the system 10 determines whether the desk surface 12 is at its elevated or lowered preset height, based on the direction of movement that is detected. By this it is meant that the system 10 detects when the movement of the desk surface 12 is upwardly, and will look for the elevated height preset, and when the movement is detected as being a lowering movement, the system 10 detects when the lowered height preset is reached. At operation 124 the system 10 uses the display 62 to provide optical signals to the user, and optionally the speaker 52 to provide an audible signal as well, to inform the user when the elevated or lowered height preset has been reached. If the system 10 detects that the desk surface 12 has been lowered from its elevated position, the system 10 may then record the previous number of minutes that the desk surface was being used in its elevated position and/or report this usage to the HR department, the user's fitness application(s) and/or a health provider, as indicated at operation 126. If the system 10 detects that the desk surface 12 has just been raised to its elevated position, the system 10 begins logging the minutes that the desk surface 12 is at its elevated position while the user is detected as being present at the desk 14. It will be appreciated that the foregoing operations represent merely one example of how the system 10 may operate, and those skilled in the art will recognize the possibility of various modifications, without departing from the spirit and scope of the present disclosure.

As noted above, the system 10 is easily retrofittable to virtually any existing work desk without modification to the work desk. The sonar sensor 22 may be located within the housing 54, which provides a single component that is placed on top of or mounted underneath the desk surface 14. Alternatively, the sonar sensor 22 may be a stand alone, independently mountable component which is linked to the remainder of the system 10 via a suitable electrical cable. This would allow the sonar sensor 22 to be mounted, for example, to the lower surface of the desk surface 12, and the remainder of the system 10 to be positioned on the floor next to the desk 14 or attached to the side of the desk 14. In either implementation, the system 10 can easily be moved from one desk to another if the need arises.

And while the system 10 has been described in connection with a desk 12, it will be appreciated that the system 10 is expected to find use with any type of table that can be raised or lowered to different heights to permit different work operations. As such, the system 10 may be used with assembly tables in a factory environment where different types of assembly operations on goods may require that a table top of an assembly table be positioned at different heights. If the system 10 includes the modification of allowing a user ID code to be entered, then the system 10 would allow the same desk height to be set for different users. This would also enable different users who have to periodically use a given table surface in a manufacturing or assembly environment to quickly and easily set the height of the table surface to a previously saved height. The system 10 may also find potential use in the food service industry, such as in connection with table surfaces used to prepare sandwiches, where different employees having significantly different heights may need to alternately use the same work surface throughout a given day. The system 10 may eliminate the need to have two or more fixed assembly tables at different heights for different assembly operations, or possibly for different users, since the system 10 allows different heights to be set for a given user, and is may be configured to allow for saved, custom height settings for different users.

And while the system 10 has been described as enabling the setting of either a raised height or lowered height (i.e., two different heights), a modification could easily be implemented to enable the system 10 to record three or more heights for a desk or assembly table for a given user/assembly technician. The use of three or more preset heights is likely to be more advantageous in a manufacturing environment, but nevertheless could easily be implemented by simply providing additional present buttons, similar to the UP control 66 and the DOWN control 68.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A furniture height adjustment system comprising:
a height adjust system configured to be positioned on or adjacent a work surface of a furniture component, wherein the work surface is movable elevationally between a lowered position and a raised position;
the height adjust system including:
a processor;
a height adjust setting control in communication with the processor, the height adjust setting control including user actuatable controls for enabling a user to set and store at least one elevational position at which the work surface can be set at;
the processor being configured to monitor movement of the work surface when the user is moving the work surface to a previously stored elevational position; and
the processor configured to generate a signal when the work surface reaches the stored elevational position.

2. The system of claim 1, wherein the height adjust system further comprises a near field wireless communications system for communication wirelessly with a personal electronic device of the user.

3. The system of claim 1, wherein the height adjust system comprises a user detection subsystem for detecting a physical presence of the user in proximity to the furniture component.

4. The system of claim 1, wherein the height adjust system comprises a display for indicating when an elevational position of the work surface is at the stored elevational position.

5. The system of claim 4, wherein the height adjust system includes a height adjust setting control including controls for enabling a user to define and store at least two elevational positions for the work surface of the furniture component.

6. The system of claim 5, wherein the controls include controls for setting at least a minimum height position and a maximum height position of the work surface.

7. The system of claim 1, wherein the height adjust system further comprises a notification generating subsystem for reminding a user of an opportunity to use the work surface in the stored elevational position for an upcoming task.

8. The system of claim 7, wherein the processor includes at least one algorithm for recognizing specific words relating to activities appearing on a calendar of the user which may be performed while standing.

9. The system of claim 8, wherein the height adjust system is able to monitor for the specific words by monitoring an email account of the user.

10. The system of claim 1, wherein the height adjust system is configured to communicate with at least one cloud based system regarding an accumulated time that the work surface is used by the user while in a standing orientation.

11. The system of claim 1, wherein the system includes a sensor for detecting a real time elevational position of the work surface of the furniture component.

12. The system of claim 11, wherein the sensor comprises a sonar sensor.

13. The system of claim 1, wherein the height adjust system monitors an elevational position of the work surface in real time.

14. The system of claim 1, wherein the system logs an accumulated standing time of the user and reports the accumulated standing time to at least one of a remote subsystem or fitness application running on a remote device.

15. A furniture height adjustment system comprising:
a height adjust system configured to be positioned on or adjacent a work surface of a furniture component, wherein the work surface is movable elevationally by a user between a lowered position and a raised position;
the height adjust system including:
a processor;
a height adjust setting control in communication with the processor, the height adjust setting control including user actuatable controls for enabling a user to set and store at least one elevational position at which the work surface can be set at;
the processor being configured to monitor movement of the work surface when the user is moving the work surface to a previously stored elevational position; and
the processor configured to generate a signal when the work surface reaches the stored elevational position; and
a user present detection system for detecting the presence of a user in a proximity to the furniture component.

16. The height adjust system of claim 15, further comprising a display system responsive to the signal generated by the processor for providing a visual indication to the user that the work surface is at the stored elevational position.

17. The height adjust system of claim 15, further comprising:
a wireless, short range transceiver for enabling the processor to communicate with a remote system, wherein the remote system includes at least one of an email account or a calendar associated with the user; and
a notification generating subsystem for analyzing words from at least one of the email account and the calendar associated with the user, and generating notifications to a personal electronic device that the user is using at the work surface to inform the user of an upcoming opportunity to use the system with the desk surface in the raised position.

18. The height adjust system of claim 15, further comprising a sonar sensor in communication with the processor for generating signals to enable the processor to determine a real time elevational position of the work surface.

19. A method for monitoring an elevational position of a work surface of a furniture component, the method comprising:
using a height adjust system configured to be positioned on or adjacent a work surface of a furniture component, wherein the work surface is movable by a user elevationally between a lowered position and a raised position, to monitor a real time elevational position of the work surface relative to a ground surface;
using a processor and a height adjust setting control in communication with the processor to enable a user to select and store at least one elevational position at which the work surface can be set at;
using the processor to monitor movement of the work surface when the user is moving the work surface to a previously stored elevational position; and
using the processor to generate a signal to the user when the work surface reaches the stored elevational position.

20. The method of claim 19, further comprising using a detection system in communication with the processor to detect a presence of the user when the user is in proximity to the furniture component.
